(19) United States
(12) Patent Application Publication
(10) Pub. No.: US 2026/0163299 A1
(43) Pub. Date: Jun. 11, 2026

(54) CONNECTOR

(71) Applicant: SUMITOMO WIRING SYSTEMS, LTD., Mie (JP)

(72) Inventor: Shiori OZEKI, Mie (JP)

(21) Appl. No.: 19/126,647

(22) PCT Filed: Oct. 18, 2023
(86) PCT No.: PCT/JP2023/037657

§ 371 Date: May 2, 2025

(30) Foreign Application Priority Data
Nov. 8, 2022 (JP) 2022-178981

(51) Int. Cl. H01R 13/627

(52) U.S. Cl. CPC H01R 13/6272

(57) ABSTRACT

A lock arm has fulcrum portions projecting from a housing body and an arm body extending in the front-rear direction and configured to tilt about the fulcrum portion in a seesaw manner in the up-down direction. The arm body has an intermediate portion continuous with the fulcrum portions, a lock portion located forward of the intermediate portion and configured to lock a partner connector, and an operating portion located rearward of the intermediate portion. The housing body has a covering wall covering the operating portion from an upper side that is opposite to a direction of displacement of the operating portion during a fitting process. The operating portion has a pressing surface at its upper surface facing the covering wall. The intermediate portion has a top surface at an upper end of its upper surface.

### TECHNICAL FIELD

The present disclosure relates to a connector.

### BACKGROUND

A connector disclosed in Patent Document 1 includes male and female housings configured to be fitted to each other. A lock arm projects from an upper surface of the female housing. The lock arm is elastically deformable and tilts in a seesaw manner about a fulcrum portion formed in an intermediate portion of the lock arm in a front-rear direction. The lock arm has a lock portion located forward of the fulcrum portion and an operating portion located rearward of the fulcrum portion. The lock portion locks a locking portion of the male housing and retains the male and female housings in a fitted state. The locking between the lock portion and the locking portion is released by pressing down the operating potion with a finger from above. Connectors with a lock structure corresponding to the lock arm are also disclosed in Patent Documents 2 and 3. In the connector of Patent Document 2, a gate piece and a ceiling wall are arranged above the operating portion of the lock arm.

### PRIOR ART DOCUMENT

### Patent Document

Patent Document 1: JP 2001-110523 A

Patent Document 2: JP 2008-235070 A

Patent Document 3: JP H09-055260 A

### SUMMARY OF THE INVENTION

### Problems to be Solved

In the connector of Patent Document 1, an area above the operating portion is open, and therefore, the operating portion may be unexpectedly pressed down.

In contrast, in the connector of Patent Document 2, the area above the operating portion is covered by the gate piece and the like, and therefore, the operating portion can be prevented from being inadvertently pressed down. However, when the gate piece and the like are arranged above the operating portion, another issue arises: the size of the connector increases in its height direction.

Therefore, an object of the present disclosure is to prevent inadvertent release operations on the lock arm while avoiding an increase in the size of the connector in the height direction.

### Means to Solve the Problem

A connector according to the present disclosure is a connector including a housing body configured to be fitted to a partner connector and an elastically deformable lock arm configured to retain the housing body and the partner connector in a fitted state, wherein the lock arm has fulcrum portions projecting from the housing body and an arm body extending in a fitting direction in which the housing body is fitted to the partner connector and configured to tilt about the fulcrum portions in a seesaw manner in a height direction intersecting the fitting direction, the arm body has an intermediate portion continuous with the fulcrum portions, a lock portion located forward of the intermediate portion in the fitting direction and configured to lock the partner connector, and an operating portion located rearward of the intermediate portion in the fitting direction, the housing body has a covering wall covering the operating portion from an upper side in the height direction, the upper side being opposite to a direction of displacement of the operating portion during a fitting process in which the housing body and the partner connector are fitted to each other, the operating portion has a pressing surface at an upper surface thereof in the height direction facing the covering wall, the intermediate portion has a top surface at an upper end of an upper surface thereof in the height direction, and the pressing surface of the operating portion is positioned below the top surface of the intermediate portion in the height direction.

### Effect of the Invention

According to the present disclosure, a connector configured to prevent inadvertent release operations on the lock arm can be provided while avoiding an increase in the size of the connector in the height direction.

### BRIEF DESCRIPTION OF THE DRAWINGS

FIG. 1 is a side cross-sectional view of a connector according to Embodiment 1.

FIG. 2 is a perspective view of a housing according to Embodiment 1 when viewed from the front.

FIG. 3 is a perspective view of the housing according to Embodiment 1 when viewed from the rear.

FIG. 4 is a rear view of the housing according to Embodiment 1.

FIG. 5 is a plan view of a lock arm according to Embodiment 1 when viewed from above, with a covering wall of the housing removed.

FIG. 6 is an enlarged side cross-sectional view showing a state in which an operating portion is pressed and locking between the lock arm and a lock portion is released, according to Embodiment 1.

FIG. 7 is a perspective view of a lock arm according to Embodiment 2 when viewed from the rear, with a covering wall of a housing removed.

FIG. 8 is an enlarged rear view showing the lock arm, and a surrounding region, of the housing according to Embodiment 2.

FIG. 9 is a side cross-sectional view showing a lock arm, and a surrounding region, of a housing according to Embodiment 3.

### DETAILED DESCRIPTION TO EXECUTE THE INVENTION

### Description of Embodiments of Present Disclosure

First, embodiments of the present disclosure will be listed and described.

(1) A connector according to the present disclosure is a connector including a housing body configured to be fitted to a partner connector and an elastically deformable lock arm configured to retain the housing body and the partner connector in a fitted state, wherein the lock arm has fulcrum portions projecting from the housing body and an arm body extending in a fitting direction in which the housing body is fitted to the partner connector and configured to tilt about the fulcrum portions in a seesaw manner in a height direction intersecting the fitting direction, the arm body has an intermediate portion continuous with the fulcrum portions, a lock portion located forward of the intermediate portion in the fitting direction and configured to lock the partner connector, and an operating portion located rearward of the intermediate portion in the fitting direction, the housing body has a covering wall covering the operating portion from an upper side in the height direction, the upper side being opposite to a direction of displacement of the operating portion during a fitting process in which the housing body and the partner connector are fitted to each other, the operating portion has a pressing surface at an upper surface thereof in the height direction facing the covering wall, the intermediate portion has a top surface at an upper end of an upper surface thereof in the height direction, and the pressing surface of the operating portion is positioned below the top surface of the intermediate portion in the height direction.

With the above configuration, the upper side of the operating portion in the height direction is covered by the covering wall, and thus, inadvertent pressing operations on the operating portion from the upper side in the height direction can be prevented. On the other hand, when a fingertip is inserted between the operating portion and the covering wall, a wedging action is exerted as the fingertip enters, pressing the pressing surface of the operating portion downward in the height direction, resulting in a state in which the locking of the lock arm can be released.

Since the pressing surface of the operating portion is positioned below the top surface of the intermediate portion in the height direction, a large distance can be provided between the pressing surface and the covering wall, ensuring that a release space in which the fingertip can be inserted can be formed between the operating portion and the covering wall without increasing the size of the connector. Note that “up” and “down” are concepts used for convenience only and do not necessarily match the direction of gravity when the connector is installed in a vehicle or the like.

(2) It is preferable that an upper surface of the arm body in the height direction includes an inclined surface that is inclined downward in the height direction from the top surface toward the pressing surface.

With the above configuration, when the operating portion is pressed, the stress acting on the operating portion can be transmitted to the inclined surface and thereby distributed. In particular, since the operating portion has the inclined surface, the operating portion can be ensured to have strength even when it is thin.

(3) It is preferable that the intermediate portion has an intermediate end surface at a lower end of a lower surface thereof in the height direction, and the operating portion has, at a lower surface thereof in the height direction, a pressing lower surface that is positioned above the intermediate end surface in the height direction.

With the above configuration, a large distance can also be provided between the pressing lower surface of the operating portion and a surface located under the operating lower surface (see an opposing portion 37 of Embodiments 1 to 3, which will be described later), ensuring that a bend space that allows the lock arm to bend can be formed between the operating portion and the opposing portion without increasing the size of the connector.

(4) It is preferable that the covering wall covers the entirety of the lock arm from the upper side in the height direction.

With the above configuration, the entire lock arm can be protected by the covering wall, and thus, inadvertent pressing operations on the operating portion from the upper side in the height direction can be prevented more reliably.

### Detailed Description of Embodiments of Present Disclosure

Specific examples of the present disclosure will be described below with reference to the drawings. It should be noted that the present invention is not limited to these examples, but rather is indicated by the scope of claims, and is intended to include all modifications within a meaning and scope equivalent to the scope of claims.

### (Embodiment 1)

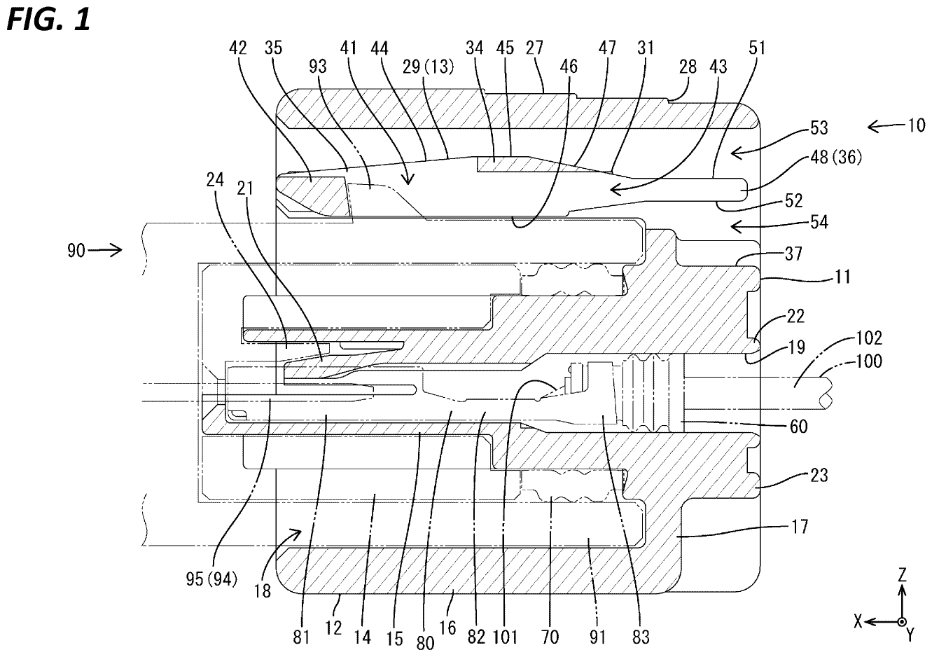

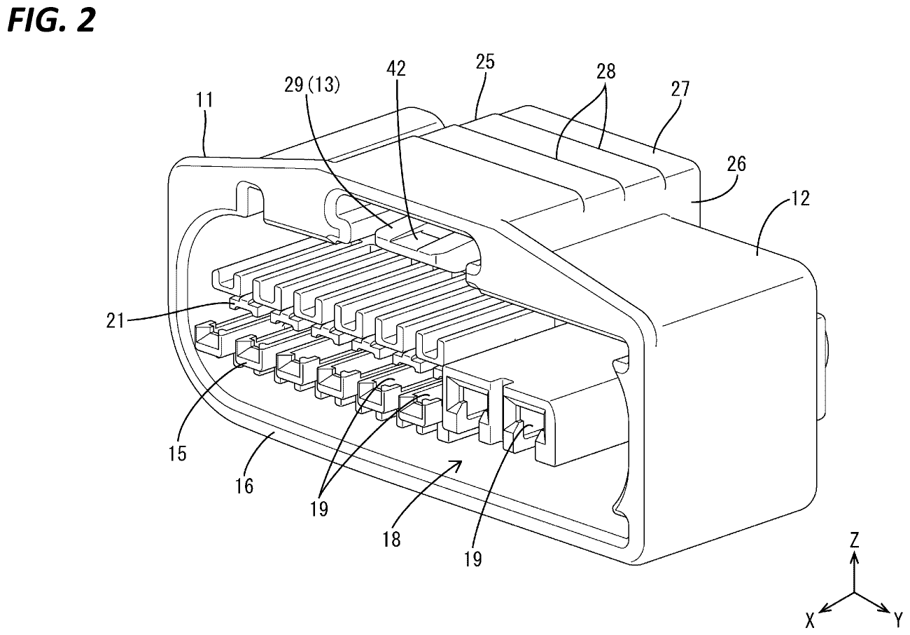

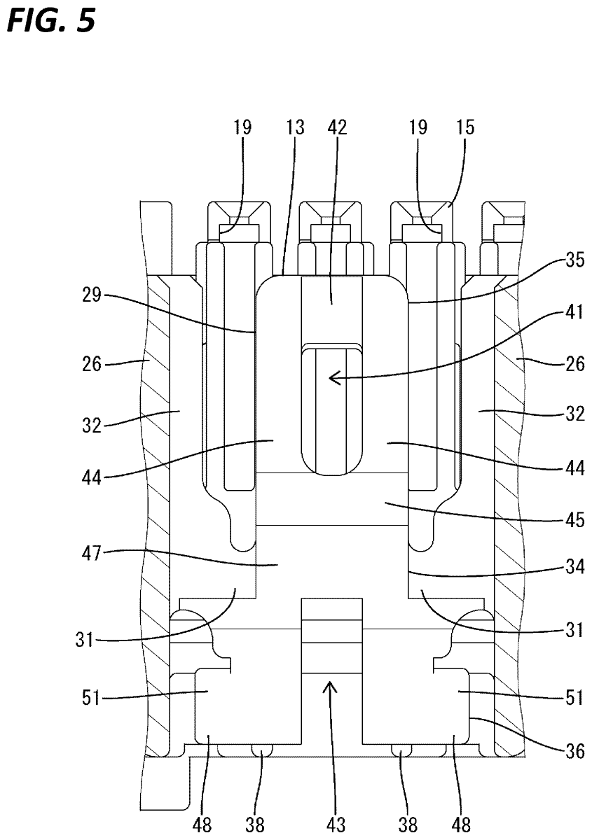

As shown in FIG. 1, a connector 10 according to Embodiment 1 of the present disclosure includes a housing 11 and terminal fittings 80. The connector 10 is a waterproof connector and includes a seal member 70 that provides a seal between the connector 10 and a partner connector 90 when fitted to the connector 10. In the following description, the front-rear direction is defined such that the side of the connector 10 that faces the partner connector 90 when they are fitted is considered the front side. The up-down direction is defined based on the up-down direction in the drawings, except for FIG. 5. The left-right direction is defined such that the right side of the connector 10 when viewed from the front is considered the right side. The up-down direction may also be referred to as the height direction, and the left-right direction may also be referred to as the width direction. In FIGS. 1 and 2, the front side, the right side, and the upper side are denoted by reference symbols X, Y, and X, respectively. These directional references are for convenience only and do not necessarily match those when the connector 10 is installed in a vehicle or the like, which is not shown.

### <Partner Connector and Connector Structure>

The partner connector 90 has a hood portion 91 made of a synthetic resin. As shown in FIG. 1, a partner lock portion 93 projects from an upper surface of an upper wall of the hood portion 91. Tabs 95 of partner terminal fittings 94 project inside the hood portion 91.

The housing 11 is made of a synthetic resin, and has a housing body 12 configured to be fitted to the hood portion 91 and a lock arm 13 projecting from the housing body 12, as shown in FIG. 1. A separate front retainer 14 is attached to the housing body 12 from the front.

The housing body 12 has a terminal accommodation portion 15, a fitting tubular portion 16 surrounding the outer periphery of the terminal accommodation portion 15, and a connecting portion 17 connecting the terminal accommodation portion 15 and the fitting tubular portion 16 to each other in the radial direction. A fitting space 18 into which the hood portion 91 is to be fitted is formed between the terminal accommodation portion 15 and the fitting tubular portion 16. The fitting space 18 is open in front of the connecting portion 17 in the housing body 12.

The seal member 70 is made of rubber such as silicone rubber, has an annular shape, and is fitted to an outer peripheral surface of the terminal accommodation portion 15.

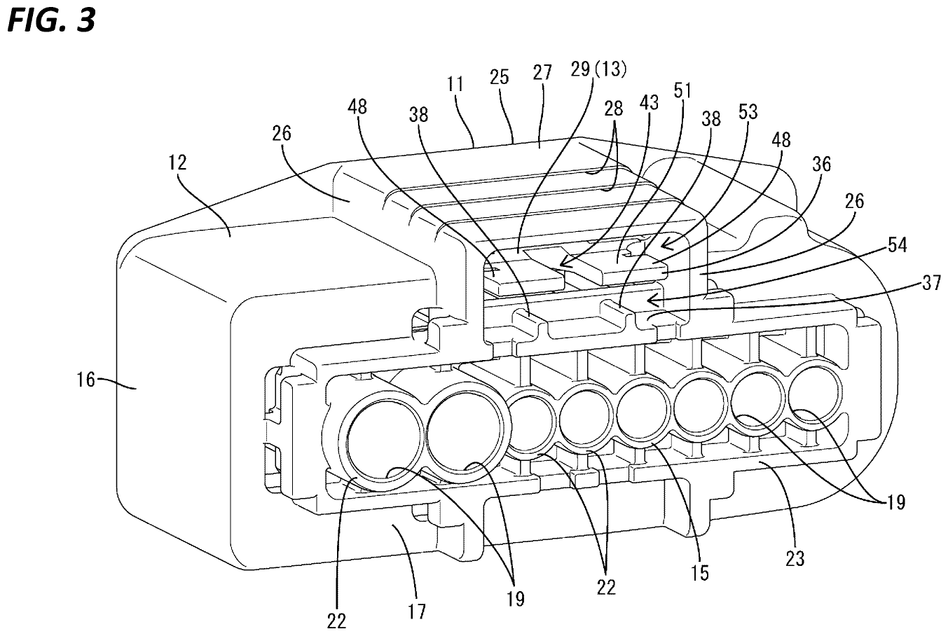

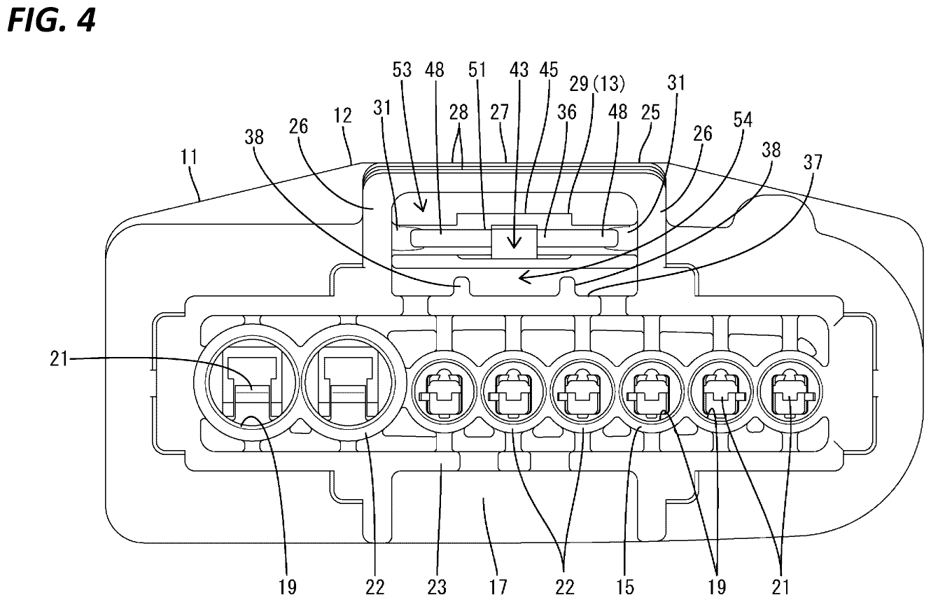

As shown in FIG. 2, the terminal accommodation portion 15 has a plurality of cavities 19. The cavities 19 are arranged side by side in the width direction within the terminal accommodation portion 15. Elastically deformable lances 21 are formed on and project forward from inner walls of the cavities 19. As shown in FIGS. 3 and 4, the terminal accommodation portion 15 has a plurality of cylindrical portions 22 projecting side by side in a single row, in the width direction, behind the connecting portion 17. Rear portions of the cavities 19 are formed inside the corresponding cylindrical portions 22. Also, the terminal accommodation portion 15 has a frame portion 23 with a rectangular shape in a rear view, the frame portion 23 projecting rearward from the connecting portion 17 and collectively surrounding the cylindrical portions 22.

As shown in FIG. 1, the terminal fittings 80 are inserted into the cavities 19 of the housing body 12 from behind. The terminal fittings 80 are made of a conductive metal, and each have a tubular connection portion 81, a wire barrel portion 82 located rearward of the connection portion 81, and an insulation barrel portion 83 located rearward of the wire barrel portion 82. The connection portion 81 is locked to the corresponding lance 21, thereby being primarily prevented from coming out of the terminal accommodation portion 15. The connection portion 81 is electrically connected to the tab 95 of the corresponding partner terminal fitting 94. The wire barrel portion 82 is crimped and electrically connected to an exposed core wire portion 101 of an end portion of an electric wire 100. The insulation barrel portion 83 is crimped and mechanically connected to a rubber plug 60 fitted to a coating portion 102 of the end portion of the electric wire 100. The rubber plug 60 is inserted into the cavity 19 together with the terminal fitting 80, and is in close contact with an inner circumferential surface of a rear portion of the cavity 19, which is the inside of the cylindrical portion 22, in a liquid-tight manner.

As shown in FIG. 1, the front retainer 14 has a restricting portion 24 for restricting the lance 21 from bending, in a state in which the front retainer 14 is attached to the terminal accommodation portion 15. The terminal fitting 80 is secondarily prevented from coming out of the terminal accommodation portion 15 by the restricting portion 24. In addition, the front retainer 14 has the function of restricting the seal member 70 from coming out forward.

As shown in FIGS. 2 and 3, the fitting tubular portion 16 has, on a center side of its upper wall, a gate-shaped protruding portion 25 that protrudes upward. Although the details will be described later, the lock arm 13 is positioned inside the protruding portion 25 in an elastically deformable manner. The protruding portion 25 is constituted by a pair of side walls 26, located on the left and right sides of the lock arm 13 and facing each other, and a covering wall 27 covering the lock arm 13 from above. Each side wall 26 extends upright in the up-down direction. A rear lower end of each side wall 26 is connected to an upper surface of the frame portion 23. The covering wall 27 is positioned to span between upper ends of the side walls 26 in the width direction.

A non-slip portion 28 with a step-like shape ascending forward is formed on an upper surface of the covering wall 27. An operator can perform the fitting operation by pressing his/her finger against the non-slip portion 28.

As shown in FIG. 5, the lock arm 13 has a plate-shaped arm body 29 that is located between the side walls 26 and extends in the front-rear direction, and a pair of fulcrum portions 31 that project from the respective side walls 26 and are connected to outer end surfaces (plate thickness surfaces) of the arm body 29 in the width direction that face the respective fulcrum portions 31. Each fulcrum portion 31 is connected, at its outer end surface in the width direction, to a rib 32 that extends rearward from a front end of the corresponding side wall 26. Each fulcrum portion 31 is inclined forward as a whole from the arm body 29 to the rib 32.

The arm body 29 has an intermediate portion 34 connected to inner end portions of the fulcrum portions 31 in the width direction, a lock portion 35 located forward of the intermediate portion 34 and configured to be locked to the partner lock portion 93, and an operating portion 36 located rearward of the intermediate portion 34 and to be pressed when releasing the locking between the lock portion 35 and the partner lock portion 93.

The arm body 29 can tilt in a seesaw manner from a horizontal state in which it is positioned so as to extend in the front-rear direction, with each fulcrum portion 31 serving as a fulcrum (center). Unless otherwise specified, the structure of the lock arm 13 that will be described below is based on the position of the arm body 29 when it is in the horizontal state.

As shown in FIG. 4, an opposing portion 37 that opposes the operating portion 36 from below is formed on the upper surface of the frame portion 23. A plurality of excessive bend restricting portions 38 for restricting excessive downward displacement of the operating portion 36 project from the opposing portion 37. Each of the excessive bend restricting portions 38 is in the form of a rib extending in the front-rear direction on the opposing portion 37, and a single pair of excessive bend restricting portions is arranged spaced apart from each other in the left-right direction.

As shown in FIG. 5, the lock portion 35 has a lock hole 41 penetrating the lock portion 35 in the up-down direction and a locking portion 42 closing a front end face of the lock hole 41. As shown in FIG. 1, when the partner lock portion 93 is fitted into the lock hole 41 and locked to a rear surface of the locking portion 42, the connector 10 and the partner connector 90 are retained in a fitted state.

The arm body 29 has a die-cut recess 43 located rearward of the locking portion 42. This die-cut recess 43 is in communication with the lock hole 41 and is open rearward. The rear surface of the locking portion 42 is formed together with the die-cut recess 43 by drawing a die (not shown) rearward. The rear surface of the locking portion 42 is inclined upward relative to the up-down direction. The lock portion 35 has, at upper surfaces of its end portions on the left and right sides of the lock hole 41, front inclined surfaces 44 inclined upward toward a top surface 45, which will be described later.

The intermediate portion 34 extends from an intermediate position of the arm body 29 in the front-rear direction that is continuous with a rear end of the lock hole 41 to a more rearward position of the arm body 29 that is continuous with the operating portion 36. As shown in FIGS. 1 and 4, an upper surface of the intermediate portion 34 includes the top surface 45 at the highest position of an upper surface of the arm body 29. The top surface 45 is formed flat along the front-rear direction and the left-right direction. As shown in FIG. 5, a front end of the top surface 45 of the intermediate portion 34 is continuous with rear ends of the front inclined surfaces 44, thereby demarcating a rear end of a top opening of the lock hole 41. As shown in FIG. 1, a lower surface of the intermediate portion 34 includes intermediate end surfaces 46 located on a side opposite to the top surface 45 and at the same height position as a lower surface of the lock portion 35. In the arm body 29, the intermediate end surfaces 46 are located at lower surfaces of end portions on the left and right sides of the die-cut recess 43.

The upper surface of the intermediate portion 34 includes an inclined surface 47 inclined downward from the top surface 45 to pressing surfaces 51, which will be described later. The inclined surface 47 is located at a position overlapping the fulcrum portions 31 with respect to the front-rear direction. As shown in FIG. 5, a front end of the inclined surface 47 is continuous with a rear end of the top surface 45 over its entire width, and a rear end of the inclined surface 47 is continuous with front ends of the pressing surfaces 51 at positions corresponding to the respective fulcrum portions 31. As shown in FIG. 1, the inclined surface 47 has a larger angle of inclination with respect to the front-rear direction than the front inclined surface 44.

As shown in FIGS. 4 and 5, the operating portion 36 has a pair of flat plate-shaped overhanging pieces 48 that are formed in a rear end portion of the arm body 29 and overhang leftward and rightward, respectively. The overhanging pieces 48 are positioned on the left and right sides of the die-cut recess 43. As shown in FIG. 5, the die-cut recess 43 extends in the front-rear direction on a center side of the arm body 29 in the width direction and is open on the rear end, and thus, a portion of the arm body 29 extending from the operating portion 36 to the rear end side of the intermediate portion 34 is open in the up-down direction.

As shown in FIG. 1, each of the overhanging pieces 48 constituting the operating portion 36 has a shape extending rearward from the intermediate portion 34 in the front-rear direction with a constant thickness, and includes the pressing surface 51 and a pressing lower surface 52 that are flat along the front-rear direction and the left-right direction.

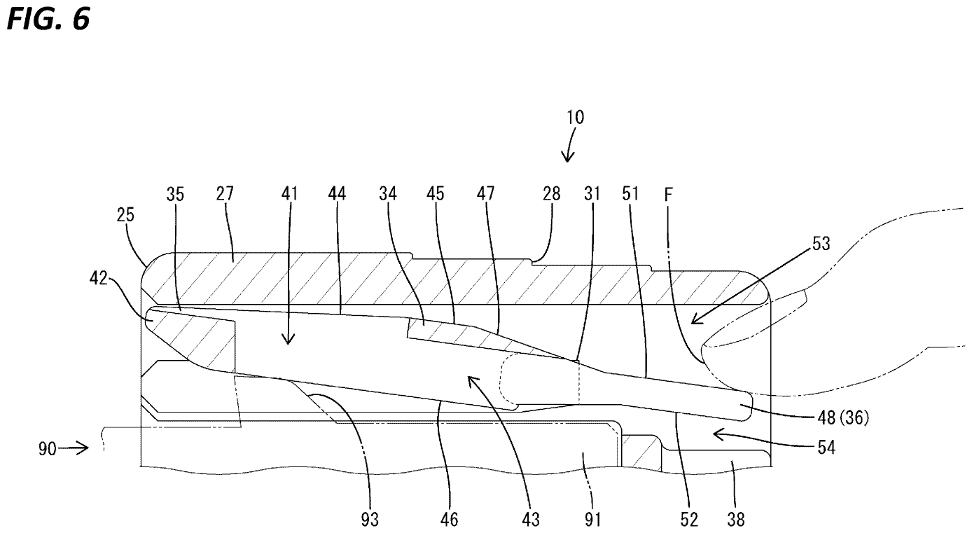

The pressing surfaces 51 constitute an upper surface of the operating portion 36 and are positioned below the covering wall 27 while being spaced apart from the covering wall 27. The pressing surfaces 51 are positioned below the top surface 45. A space between the covering wall 27 and the pressing surfaces 51 of the operating portion 36 is configured as a release space 53 that allows the tip of a finger such as a thumb (hereinafter referred to as a fingertip F (see FIG. 6)) to enter when releasing the locking between the lock arm 13 and the partner lock portion 93.

The pressing lower surfaces 52 constitute a lower surface of the operating portion 36 and are positioned above the excessive bend restricting portion 38 while being spaced apart from the excessive bend restricting portion 38. The pressing lower surfaces 52 are positioned above the intermediate end surfaces 46. A space between the opposing portion 37 and the pressing lower surfaces 52 of the operating portion 36 is configured as a bend space 54 that allows downward displacement of the operating portion 36 during the fitting and disengaging of the connector 10. The thickness in the height direction of the operating portion 36, which is defined between each pressing surface 51 and the corresponding pressing lower surface 52, is set to be thinner than the thickness in the height direction of the locking portion 42.

### <Effect of Connector>

During the process in which the hood portion 91 of the partner connector 90 is fitted into the fitting space 18 of the housing body 12, when the partner lock portion 93 interferes with the locking portion 42, the arm body 29 tilts from the horizontal state using the fulcrum portions 31 as fulcrums. Specifically, the lock portion 35 is displaced so as to be inclined upward, and the operating portion 36 is displaced so as to be inclined downward within the bend space 54. After that, the partner lock portion 93 leaves the locking portion 42, and the arm body 29 elastically returns to the horizontal state. As a result, the partner lock portion 93 fits into the lock hole 41 as shown in FIG. 1, and the connector 10 and the partner connector 90 are retained in a fitted state. In this fitted state of the connector 10, the terminal fittings 80 and the partner terminal fittings 94 are electrically connected to each other. In addition, the seal member 70 is sandwiched between the hood portion 91 and the terminal accommodation portion 15, and a space between the connector 10 and the partner connector 90 is sealed in a liquid-tight manner.

When disengaging the connector 10 and the partner connector 90 from each other for purposes such as maintenance, the fingertip F is inserted, from behind, into the release space 53, formed between the operating portion 36 and the covering wall 27, as shown in FIG. 6. As the fingertip F enters the release space 53, a wedging action corresponding to the shape of the fingertip F is exerted to push the operating portion 36 down into the bend space 54. In this case, it is preferable that the pad side of the fingertip F displaces the pressing surfaces 51 of the operating portion 36 downward, and the opposite side, that is, the nail side of the fingertip F is pressed against the covering wall 27 while receiving an elastic reaction force of the lock arm 13.

When the operating portion 36 is pressed down by the fingertip F, the lock portion 35 is inclined upward, the locking portion 42 then separates from the partner lock portion 93, and the locking between the lock arm 13 and the partner lock portion 93 is released. In this state, the housing body 12 is pulled away from the hood portion 91, and thus, the connector 10 and the partner connector 90 are disengaged from each other.

According to Embodiment 1, since the pressing surfaces 51 of the operating portion 36 are covered by the covering wall 27, inadvertent release operations on the operating portion 36 can be prevented, and the connector 10 and the partner connector 90 can be maintained in the fitted state. On the other hand, when the fingertip F is inserted into the release space 53, formed between the covering wall 27 and the operating portion 36, and the operating portion 36 is pressed down, the connector 10 and the partner connector 90 can be properly released from the fitted state.

When the covering wall 27 is positioned above the operating portion 36 and the release space 53 is formed between the operating portion 36 and the covering wall 27 as described above, there is a concern that the size of the housing 11 will increase in the height direction. However, in the case of Embodiment 1, since the pressing surfaces 51 of the operating portion 36 are positioned below the top surface 45 of the intermediate portion 34, the increase in the size of the housing 11 in the height direction can be suppressed.

In addition, since the pressing lower surfaces 52 of the operating portion 36 are positioned above the intermediate end surfaces 46 of the intermediate portion 34, the bend space 54 can be provided between the pressing lower surfaces 52 of the operating portion 36 and the opposing portion 37, which opposes the pressing lower surfaces 52, without increasing the size of the housing 11 in the height direction.

Furthermore, since the inclined surface 47 extending from the top surface 45 toward the pressing surfaces 51 is formed at the upper surface of the arm body 29, stress acting on the operating portion 36 when the operating portion 36 is pressed can be transmitted to the inclined surface 47 and thereby distributed. As a result, the operating portion 36 can be ensured to have strength even when it is formed to be thin.

Furthermore, since the covering wall 27 is positioned so as to cover the entire lock arm 13 from above, the lock arm 13 is protected from external foreign matter, and inadvertent release operations on the operating portion 36 can also be prevented more reliably.

### (Embodiment 2)

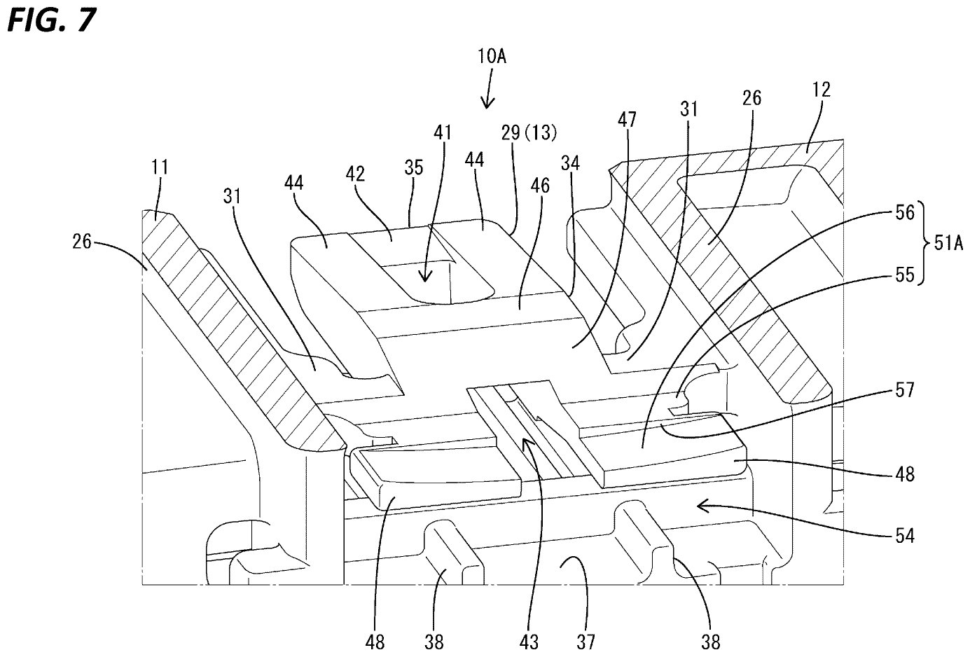

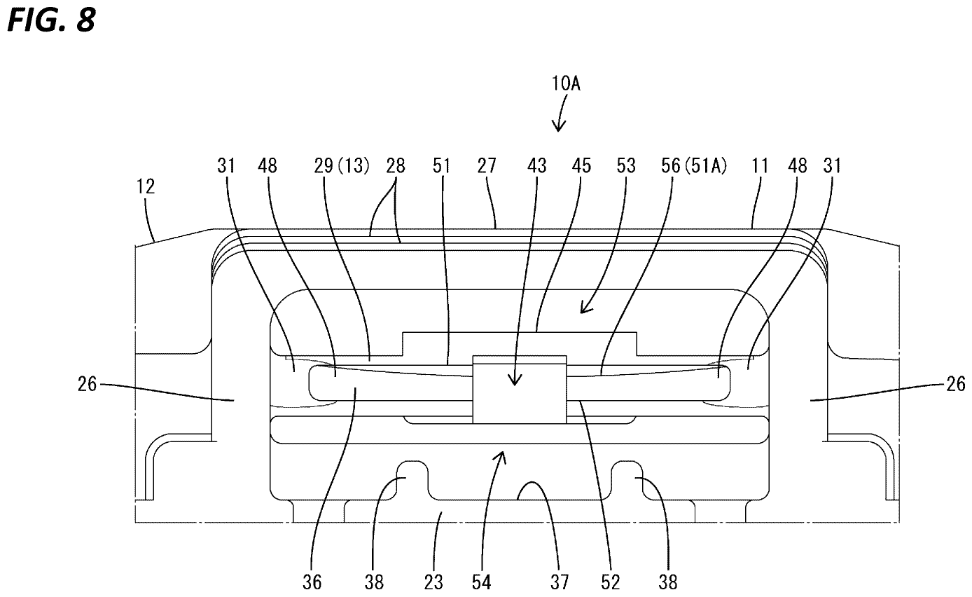

As shown in FIGS. 7 and 8, a connector 10A of Embodiment 2 of the present disclosure is different from that of Embodiment 1 in terms of the form of pressing surfaces 51A. Otherwise, Embodiment 2 is the same as Embodiment 1, and in Embodiment 2, portions that are the same as or correspond to those of Embodiment 1 are denoted by the same reference numerals, and redundant descriptions are omitted.

As shown in FIG. 7, each pressing surface 51A has a flat surface 55 that extends from the front end side of the operating portion 36 to the rear end side of the intermediate portion 34 and is flat along the front-rear direction and the left-right direction, as well as a curved surface 56 that curves downward toward the die-cut recess 43, which is located on the center side of the corresponding overhanging piece 48 in the width direction. A front end of the curved surface 56 is connected to a rear end of the flat surface 55 via a step 57 in the height direction. The curved surfaces 56 are formed over the entire width of the operating portion 36. As shown in FIG. 8, the pressing lower surfaces 52, which constitute the lower surface of the operating portion 36, are formed flat along the width direction.

When disengaging the connector 10A and the partner connector 90 from each other, the operating portion 36 is pushed down by the curved surfaces 56 being pressed by the fingertip F, and thus, the locking between the lock arm 13 and the partner lock portion 93 is released. In this case, since the pad side of the fingertip F can be placed along the curved surfaces 56, the pain in the fingertip F during the operation can be reduced, and a pressing force applied to the curved surfaces 56 can be stably transmitted to the operating portion 36. In addition, the stress acting on the operating portion 36 can be widely distributed along the curved surfaces 56.

### (Embodiment 3)

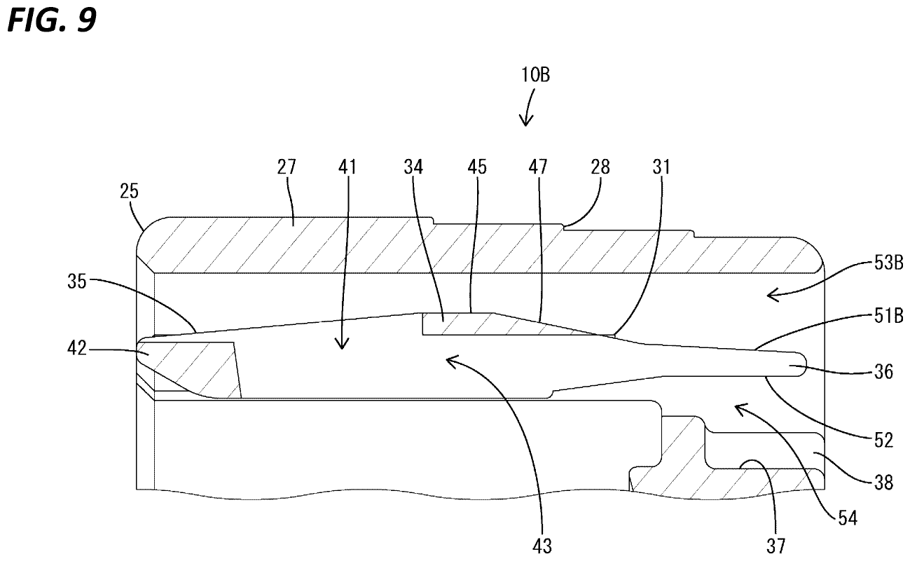

As shown in FIG. 9, a connector 10B of Embodiment 3 of the present disclosure is different from that of Embodiment 1 in terms of the form of pressing surfaces 51B, as is the case with Embodiment 2. Otherwise, Embodiment 3 is the same as Embodiment 1, and in Embodiment 3, portions that are the same as or correspond to those of Embodiment 1 are denoted by the same reference numerals, and redundant descriptions are omitted.

Each pressing surface 51B is inclined downward as a whole from the inclined surface 47 toward the rear end of the operating portion 36. The pressing surfaces 51B have a smaller angle of inclination with respect to the front-rear direction than the inclined surface 47. Front ends of the pressing surfaces 51B intersect the rear end of the inclined surface 47 at an obtuse angle.

A release space 53B formed between the operating portion 36 and the covering wall 27 is configured to expand in the up-down direction rearward due to the inclined shape of the pressing surfaces 51B.

When the fingertip F is inserted into the release space 53B to disengage the connector 10B and the partner connector 90 from each other, a wedging action corresponding to the inclined shape of the pressing surfaces 51B and the shape of the fingertip F is effectively exerted to thereby smoothly push the operating portion 36 down into the bend space 54. In addition, when the operating portion 36 is pressed, the stress acting on the operating portion 36 can be widely distributed along the inclined shape of the pressing surfaces 51B.

### Other Embodiments of Present Disclosure

Embodiments 1 to 3 disclosed herein are illustrative in all respects and not intended to be construed as limiting.

In the case of Embodiments 1 to 3, the connector is a waterproof connector with a waterproof means, such as a seal member. However, according to other embodiments, the connector may be a non-waterproof connector without a waterproof means, such as a seal member.

In the case of Embodiments 1 to 3, the fulcrum portions project from the inner surfaces of the sidewalls and are connected to the plate thickness surfaces of the arm body. However, according to other embodiments, the fulcrum portions may project from an upper surface of the terminal accommodation portion and be connected to the lower surface of the arm body.

In the case of Embodiments 1 to 3, the fingertip is inserted into the release space formed between the operating portion and the covering wall to release the locking between the lock arm and the partner lock portion. However, according to other embodiments, a rod-shaped jig may be inserted into the release space formed between the operating portion and the covering wall to release the locking between the lock arm and the partner lock portion.

In the case of Embodiment 3, the pressing surfaces and the inclined surface have different angles of inclination with respect to the front-rear direction. However, in other embodiments, the pressing surfaces and the inclined surface may be continuous with each other while having the same angle of inclination with respect to the front-rear direction.

### LIST OF REFERENCE NUMERALS

10, 10A, 10B Connector
11 Housing
12 Housing body
13 Lock arm
14 Front retainer
15 Terminal accommodation portion
16 Fitting tubular portion
17 Connecting portion
18 Fitting space
19 Cavity
21 Lance
22 Cylindrical portion
23 Frame portion
24 Restricting portion
25 Protruding portion
26 Side wall
27 Covering wall
28 Non-slip portion
29 Arm body
31 Fulcrum portion
32 Rib
34 Intermediate portion
35 Lock portion
36 Operating portion
37 Opposing portion
38 Excessive bend restricting portion
41 Lock hole
42 Locking portion
43 Die-cut recess
44 Front inclined surface
45 Top surface
46 Intermediate end surface
47 Inclined surface
48 Overhanging piece
51, 51A, 51B Pressing surface
52 Pressing lower surface
53, 53B Release space
54 Bend space
55 Flat surface
56 Curved surface
57 Step
60 Rubber plug
70 Seal member
80 Terminal fitting
81 Connection portion
82 Wire barrel portion
83 Insulation barrel portion
90 Partner connector
91 Hood portion
93 Partner lock portion
94 Partner terminal fitting
95 Tab
100 Electric wire
101 Core wire portion
102 Coating portion
F Fingertip

1. A connector integrally comprising:
a housing body configured to be fitted to a partner connector; and
an elastically deformable lock arm configured to retain the housing body and the partner connector in a fitted state,
wherein the lock arm has fulcrum portions projecting from the housing body and an arm body extending in a fitting direction in which the housing body is fitted to the partner connector and configured to tilt about the fulcrum portions in a seesaw manner in a height direction intersecting the fitting direction,
the arm body has an intermediate portion continuous with the fulcrum portions, a lock portion located forward of the intermediate portion in the fitting direction and configured to lock the partner connector, and an operating portion located rearward of the intermediate portion in the fitting direction,
the housing body has a covering wall covering the operating portion from an upper side in the height direction, the upper side being opposite to a direction of displacement of the operating portion during a fitting process in which the housing body and the partner connector are fitted to each other,
the operating portion has a pressing surface at an upper surface thereof in the height direction facing the covering wall,
the intermediate portion has a top surface at an upper end of an upper surface thereof in the height direction,
the pressing surface of the operating portion is positioned below the top surface of the intermediate portion in the height direction,
the lock portion has a lock hole penetrating the arm body in the height direction and a locking portion closing a front end of the lock hole in the fitting direction, and
a partner lock portion of the partner connector is to be fitted into the lock hole and locked to the locking portion.

2. The connector according to claim 1,
wherein an upper surface of the arm body in the height direction includes an inclined surface that is inclined downward in the height direction from the top surface toward the pressing surface.

3. The connector according to claim 1,
wherein the intermediate portion has an intermediate end surface at a lower end of a lower surface thereof in the height direction, and
the operating portion has, at a lower surface thereof in the height direction, a pressing lower surface that is positioned above the intermediate end surface in the height direction.

4. The connector according to claim 1,
wherein the covering wall covers the entirety of the lock arm from the upper side in the height direction.

5. The connector according to claim 3,
wherein an upper surface of the arm body in the height direction is inclined downward in the height direction from the top surface toward the pressing surface.

6. The connector according to claim 2,
wherein the housing body has a pair of side walls that are located on opposite sides of the lock arm and face each other,
the fulcrum portions project from the respective side walls and are connected to end surfaces of the arm body that face the respective fulcrum portions, and
locations where the fulcrum portions are connected to the end faces of the arm body are arranged at positions overlapping the inclined surface with respect to the fitting direction.

7. The connector according to claim 1,
wherein the arm body has a die-cut recess located rearward of the locking portion in the fitting direction, the die-cut recess being in communication with the lock hole and being open rearward in the fitting direction, and
the die-cut recess penetrates the operating portion in the heigh direction.
